(19) United States
(12) Patent Application Publication
(10) Pub. No.: US 2024/0399718 A1
(43) Pub. Date: Dec. 5, 2024

(54) LAMINATED PANE FOR A HEAD-UP DISPLAY SYSTEM WITH P-POLARIZED RADIATION

(71) Applicant: SAINT-GOBAIN GLASS FRANCE, COURBEVOIE (FR)

(72) Inventor: Jan HAGEN, HERZOGENRATH (DE)

(21) Appl. No.: 18/693,075

(22) PCT Filed: Dec. 1, 2022
(86) PCT No.: PCT/EP2022/084057

§ 371 Date: Mar. 18, 2024

(30) Foreign Application Priority Data
Dec. 7, 2021 (EP) 21212777.3

(51) Int. Cl. B32B 17/10; G02B 27/01; G02B 27/28

(52) U.S. Cl. CPC B32B 17/10458; B32B 17/10339; B32B 17/10449; G02B 27/0101; G02B 27/288; B32B 17/1077; B32B 17/10788; B32B 2307/204; B32B 2307/416

(57) ABSTRACT

A laminated pane for a head-up display system, includes a first coating on a second surface of a first pane, a second coating on a surface of a second pane, an HUD region having the first coating and the second coating, wherein the first coating and the second coating are provided for reflecting p-polarized radiation, wherein a refractive index of the first coating is at least 1.9, wherein the second coating includes at least one first layer of a dielectric material having a refractive index of greater than or equal to 1.9 and a second layer of a dielectric material having a refractive index of less than or equal to 1.6, and wherein the second pane has a smaller thickness than the first pane, and wherein the first coating and the second coating have exclusively dielectric layers.

The invention relates to a laminated pane for a head-up display system and to a projection arrangement for a head-up display.

Vehicles, in particular passenger vehicles, are increasingly being equipped with so-called head-up displays. A head-up display (HUD) is a display system which projects additional information in the form of images into the field of view of a driver of a vehicle.

The head-up display consists of a projector (imaging unit) and a plurality of optics modules for deflecting or mirroring (reflecting) an image onto a projection surface or reflection surface. A laminated pane, in particular the windshield of the vehicle, usually serves as a projection surface. A laminated pane generally has two panes which are laminated onto an intermediate layer. The intermediate layer usually comprises a thermoplastic material, preferably polyvinyl butyral (PVB), of a predetermined thickness. Although the image is projected onto the windshield, it is perceived by the human eye of the driver to float above the engine hood of the vehicle.

In this way, additional information can be projected into the field of vision of the driver, for example the current travel speed and navigation messages or warnings that the driver can perceive without having to change their viewing direction. Head-up displays can accordingly contribute substantially to increasing traffic safety.

Usually, the image generated by the projector consists of polarized, in particular s-polarized light radiation. The s-polarized light impinges on the laminated pane at a certain angle of incidence and is at least partially refracted into the laminated pane and reflected as s-polarized light into the field of view of the driver. However, the reflected images are not shown true to color, or are shown with undesired reflection, so-called double images.

The angle of incidence of the s-polarized radiation is usually about 65%, which corresponds approximately to the Brewster angle for an air-glass transition (57.2° for soda-lime glass). The problem here is that the projector image is reflected at both outer transitions from air to glass and from glass to air. As a result, in addition to the desired main image, a slightly offset secondary image also occurs, the so-called ghost image. The problem is reduced in that the surfaces of the windshield are arranged at an angle to one another. This is done by using a wedge-shaped intermediate layer during lamination of the windshield designed as a laminated pane. A superposition of the main image and the ghost image can thereby be achieved.

It is thus possible, for example, to operate the HUD projector with p-polarized radiation which is not substantially reflected at the pane surfaces due to irradiation close to the Brewster angle. As a reflection surface for the p-polarized radiation, the windshield instead has a reflective coating, in particular with metallic and dielectric layers. HUD projection arrangements with reflective coating are known from WO2019179682A1, WO2019179683A1, WO2019206493A1 and WO2021/104800 A1. While the reflection at the outer-side surface of the outer pane is weakened as a result of the radiation reflection at the reflection coating, in particular the reflection at the interior-side surface of the inner pane can occur as weak, yet nevertheless disturbing ghost images. Since high-frequency signals are not transmitted through the reflective coating, the transmission and reception of electromagnetic radiation in the interior of a vehicle is no longer possible. Usually, one or two locally delimited regions of the reflective coating are therefore decoated.

CN113071165 A discloses an HUD system comprising an HUD glass. The HUD glass comprises two glass plates, a middle layer arranged between the glass plates, and a transparent conductive film and a reflection-increasing film.

The object of the present invention is to provide a laminated pane with an intermediate layer having a wedge-shaped cross section for a head-up display system, which laminated pane improves the reflectivity for p-polarized radiation in the visible spectral range and is substantially permeable to high-frequency signals on its entire surface.

The object of the present invention is achieved according to the invention by a laminated pane according to claim 1. Preferred embodiments are apparent from the dependent claims.

The laminated pane according to the invention for a head-up display (HUD) system has a first pane and a second pane, which are connected to one another via a thermoplastic intermediate layer having a wedge-shaped cross section. The thermoplastic intermediate layer has a thicker first end and a thinner second end. The increase in thickness from the second end to the first end can be continuously linear or non-linear. The first pane has a first surface (I) and a second surface (II). The second pane also has a first surface (III) and a second surface (IV).

Furthermore, the laminated pane has an HUD region and a first coating and a second coating, wherein the HUD region has the first coating and the second coating. The first coating is arranged on the second surface (II) of the first pane facing the intermediate layer, and the second coating is arranged on the second surface (IV) of the second pane facing away from the intermediate layer.

A refractive index of the first coating is at least 1.9. The second coating comprises at least one first layer of a dielectric material having a refractive index of greater than or equal to 1.9 and a second layer of a dielectric material having a refractive index of less than or equal to 1.6. Both coatings, i.e., the first coating and the second coating, are provided and suitable for reflecting p-polarized radiation. The inventors have found that a coating comprising a high-refractive layer and a low-refractive layer is particularly suitable as regards high reflectivity for p-polarized light. The p-polarized radiation is reflected by the first coating and by the second coating. The transmitted portion of the radiation is reflected on the first coating located in the laminated pane. Since the second pane has a low thickness, the two reflected images overlap almost completely. As a result, the intensity of the HUD representation (projector image) resulting from the reflections is increased.

The first coating does not have to be applied over the entire surface of the surface (II) of the first pane, but must be applied at least in the HUD region of the laminated pane.

The first pane can be characterized by a tinting, which improves visibility of the HUD representation; in combination with the second pane, which has a lower thickness than the first pane, visibility of the HUD representation can be further increased. Such a laminated pane has the particular advantage that it has reflective properties in the visible spectral range, in particular with respect to p-polarized radiation. In addition, the formation of undesired reflection is largely minimized and ensures transmission of high-frequency signals on almost the entire surface of the laminated pane.

In other words, according to the invention, it is provided for the laminated pane to comprise the first coating and the second coating for reflecting p-polarized radiation, wherein the second pane has a small thickness as a result of which the two reflections overlap as far as possible. The tinting of the first pane further enhances this effect. Surprisingly, it has been found that such a laminated pane according to the invention allows for a significantly improved visibility of the main image compared to the laminated panes known so far.

In a particularly preferred embodiment, the first coating and the second coating have exclusively dielectric layers. In addition, the first coating and the second coating can be free of electrically conductive materials. This ensures very good transmission of electromagnetic radiation through the laminated pane. It may be desirable also for legal reasons for a laminated pane, in particular a vehicle window pane, to have no metallic layers.

In a preferred embodiment, the first coating comprises a dielectric layer based on silicon zirconium mixed nitride, silicon nitride, silicon titanium mixed nitride, silicon hafnium mixed nitride and/or titanium oxide.

In a further embodiment, the first coating comprises exclusively a dielectric layer, in particular based on silicon zirconium mixed nitride.

In a further preferred embodiment, the first layer of the second coating comprises a dielectric layer based on silicon zirconium mixed nitride, silicon nitride, silicon titanium mixed nitride, silicon hafnium mixed nitride or titanium oxide, and the second layer of the second coating comprises a dielectric layer based on a dielectric oxide, in particular silicon oxide (SiO₂). The second coating is preferably formed only of these two layers. It preferably does not have any further layers below or above one of the two layers. The first layer and the second layer preferably together comprise two or more layers having a different refractive index. The refractive index here is greater than or equal to 1.9 for each layer of the first, in particular highly refractive layer, and is less than or equal to 1.6 for the second, in particular low-refractive layer.

The second coating can have a total material thickness of at most 200 nm (nanometers), preferably at most 185 nm.

The laminated pane is provided to separate the interior from the external environment in a window opening of a vehicle. The laminated pane is preferably the windshield of a motor vehicle, in particular of a passenger vehicle or truck. From the viewpoint of a vehicle occupant, the second coating is arranged spatially in front of the first coating when looking through the second pane (e.g., inner pane).

As usual with HUDs, a projector irradiates a region of the windshield where the radiation is reflected towards the viewer (driver), thereby generating a virtual image that the viewer perceives from behind the windshield. The region of the windshield that can be irradiated by the projector is referred to as the HUD region. The beam direction of the projector can be varied by optical elements (e.g., mirrors), in particular vertically, in order to adapt the projection to the body size of the viewer.

P-polarized radiation is used to generate an HUD image.

Since the angle of incidence of approximately 65°, which is typical for HUD projection arrangements, is relatively close to the Brewster angle for an air-glass transition (57.2°, soda-lime glass), p-polarized radiation is hardly reflected by disk surfaces, while s-polarized radiation is reflected much more strongly. The reflection of the p-polarized radiation takes place mainly at the second coating.

In a preferred embodiment of the laminated pane according to the invention, the thermoplastic intermediate layer has a wedge angle in the range of 0.1 mrad to 1 mrad, preferably 0.3 mrad to 0.6 mrad. Since the laminated pane according to the invention comprises a thermoplastic intermediate layer with a wedge-shaped cross section and two panes with a constant thickness or with a wedge-shaped cross section, the laminated pane according to the invention has a wedge-shaped cross section.

It shall be appreciated that cross section means the cross section in the vertical course between a lower edge and an upper edge. With the laminated pane according to the invention, the thickness increases from the lower edge to the upper edge. The thicker first end is thus located at the upper edge, and the thinner second end is located at the lower edge of the laminated pane. In automotive engineering, the thickness is typically varied such that the smallest thickness is provided at the lower end of the laminated glass pane toward the engine compartment, while the thickness increases toward the roof.

The thermoplastic intermediate layer can also comprise an additional intermediate layer which has an essentially constant thickness, in particular a layer reflecting infrared radiation, a layer absorbing infrared radiation, a layer absorbing UV radiation, a barrier layer, an intermediate layer with acoustically damping properties, or a combination thereof. For example, the additional intermediate layer can also be a bandpass filter film. The additional intermediate layer can be arranged between the first and the second pane.

In order to reduce the transmission of the total thermal radiation, the intermediate layer can have thermal radiation (total transmitted heat radiation TTS) reducing properties. For this purpose, the additional intermediate layer can be designed as a film having absorbing properties in the near infrared range (NIR). Electromagnetic radiation in a wavelength range 780 nm to 3000 nm (nanometers) is referred to as near-infrared radiation (NIR). As a result, warming inside of rooms or vehicles is minimized and the energetic effort for creating an ambient climate that is pleasant for people in such rooms or vehicles is reduced.

In one embodiment, the intermediate layer can comprise a conductor system with heating function, in particular a plurality of resistance wires as heating conductors.

In a further embodiment, at least one cover layer, in particular an opaque cover print, is arranged on the interior-side surface (II) of the first pane in an edge region of the laminated pane. The opaque cover layer can be arranged indirectly or directly on the pane surface. In this case, the cover layer can at least partially overlap with the HUD region in the look-through direction of the laminated pane.

The opaque cover layer is arranged in the same region of the pane as the first and the second coating, so that the cover layer, the first coating and the second coating overlap at least partially in the look-through direction of the laminated pane. Since, in the installed state of the laminated pane, the HUD projector is arranged in the interior of a vehicle, the light emitted by the HUD projector impinges on the second coating or first coating and is reflected there in each case. The reflected light can be seen as an image by a viewer located in the vehicle interior. The opaque cover layer lies behind the first coating as seen by a viewer located inside the vehicle. As a result, the image in the region of the first coating has good contrast.

The cover layer covers, for example, an adhesive bonding or electrical connection elements of the laminated pane. An aesthetically good visual impression of the laminated pane is thereby achieved. The cover layer also serves as UV protection for, for example, adhesive in the edge region of the laminated pane.

The at least one opaque cover layer within the meaning of the invention is a layer that prevents the view through the laminated pane. In this case, at most 5%, preferably at most 2%, particularly preferably at most 1%, in particular at most 0.1%, of the light of the visible spectrum is transmitted through the opaque cover layer. The cover layer can also be designed to be semi-transparent, at least in sections—for example, as a dot matrix, stripe matrix, or checkered matrix. Alternatively, the cover layer can also have a gradient—for example, from an opaque coverage to a semi-transparent coverage.

The opaque cover layer is preferably printed on the first pane (e.g., outer pane), in particular in a screen printing method. Screen printing methods for applying opaque cover layers to panes are known as such. Such printed cover layers are also referred to as screen print or black print and contain an opaque pigment, for example a black pigment. Known black pigments are, for example, carbon black, aniline black, leg black, iron oxide black, spinel black, and graphite. The opaque cover layer can be formed circumferentially along the circumferential edge of the laminated pane in the edge region of the laminated pane, wherein the width of the opaque cover layer may vary. The opaque cover layer is preferably widened at least in one region. This widened region of the opaque cover layer can serve to display images emitted by the HUD projector.

In a further embodiment of the invention, the thermoplastic intermediate layer is opaque in at least the edge region of the laminated pane. The thermoplastic intermediate layer is preferably colored black in the portion of the edge region. Alternatively, the thermoplastic intermediate layer can also be formed by a first and a second thermoplastic laminated film, wherein the first thermoplastic laminated film is transparent and extends over the entire surface of the laminated pane with the exception of the edge region. The second thermoplastic laminated film is opaque and, for example, black, and extends at least, preferably exclusively, over the edge region of the laminated pane.

In yet another embodiment of the invention, an opaque, preferably black, film is arranged within the thermoplastic intermediate layer. The film extends at least over the edge region and preferably only over the edge region. The film is formed, for example, on the basis of polyethylene terephthalate.

The edge region is preferably a strip-like region which is arranged along the lower edge. The edge region thus extends from the left side edge to the right side edge and along the lower edge of the laminated pane. However, the edge region can also extend in a strip-like manner along the upper edge from the left-hand to the right-hand side edge and/or along the left-hand and/or the right-hand side edge from the lower edge to the upper edge. The edge region particularly preferably borders directly on the upper, side, and/or lower edge. The edge region can run circumferentially along the laminated pane in a frame-like manner. The edge region is not arranged within the region of the laminated pane, which region is provided as a look-through region, for example in the course of use as a windshield in a vehicle. The width of the edge region is preferably 10 cm to 50 cm. “Width” within the meaning of the invention means the extent perpendicular to the extension direction.

In principle, it is sufficient if the HUD region of the laminated pane, in particular as a windshield, is provided with the first coating and the second coating. However, further regions can also be provided with the first and second coating. The laminated pane can be provided with the first and second coating substantially over the entire surface, which may be preferred for production reasons.

In one embodiment of the invention, at least 80% of the pane surface is provided with the first and second coating. In particular, the first and second coating is applied over the entire surface of the pane with the exception of a circumferential edge region and optionally local region. The peripheral uncoated edge region has, for example, a width of up to 20 cm.

The laminated pane according to the invention effects high reflectivity to p-polarized radiation in the spectral range of 450 nm to 650 nm (nanometers), which is relevant for HUD representations. HUD projectors typically operate with wavelengths of 473 nm, 550 nm and 630 nm (RGB). A strong-intensity HUD image is thereby achieved.

The projector is arranged on the interior side of the laminated pane and irradiates the laminated pane via the second (interior-side) surface of the second pane. The light emitted by the HUD projector impinges on the HUD region and/or the cover print and is reflected there.

In the context of the invention, the outer surface means the surface which is provided to face the external environment when installed. In the context of the invention, the interior-side surface means the surface which is intended to face the interior space when installed.

The projector is directed toward the HUD region and/or the cover layer and irradiates it for generating the HUD projection. According to the invention, the radiation of the projector is predominantly p-polarized, i.e., has a p-polarized radiation portion of greater than 50%. The higher the share of p-polarized radiation in the projector's total radiation, the more intense the desired projection image.

The projector's p-polarized radiation portion is preferably at least 70%, particularly preferably at least 80%, and very particularly preferably at least 90%. In a particularly advantageous embodiment, the radiation from the projector is substantially purely p-polarized, i.e., the p-polarized radiation portion is 100% or deviates only insignificantly therefrom. The indication of the polarization direction refers to the plane of incidence of the radiation on the laminated pane, in particular the windshield. P-polarized radiation refers to a radiation the electric field of which oscillates in the plane of incidence. P-polarized radiation refers to a radiation, the electric field of which oscillates perpendicular to the plane of incidence. The plane of incidence is spanned by the incident vector and the surface normal of the windshield in the geometric center of the irradiated region.

The radiation of the projector preferably impinges on the windshield at an angle of incidence of 45° to 75°, in particular of 60° to 70°. In an advantageous embodiment, the angle of incidence deviates by at most 10° from the Brewster angle. The angle of incidence is the angle between the vector of incidence of the projector radiation and the interior-side surface normal (that is to say the surface normal on the interior-side external surface of the windshield) at the geometric center of the HUD region. The Brewster angle for an air-glass transition in the case of soda-lime glass, which is generally common for window panes, is 57.2°. Ideally, the angle of incidence should be as close as possible to this Brewster angle. However, angles of incidence of 65°, for example, can also be used, which are common for HUD projection arrangements, are easy to implement in vehicles and deviate only slightly from the Brewster angle so that the reflection of the p-polarized radiation increases only insignificantly.

The laminated pane has a peripheral edge, which particularly preferably comprises an upper edge and a lower edge and two side edges running between them with a left and a right side edge. Upper edge means the edge intended to point upward in the installed position of the laminated pane. Lower edge means the edge intended to point downward in the installed position. The upper edge is often also referred to as the roof edge, and the lower edge is often also referred to as the engine edge.

The thermoplastic intermediate layer is typically formed from at least one thermoplastic film. The thermoplastic intermediate layer can also have a multilayered structure, i.e., the thermoplastic intermediate layer can comprise a plurality of thermoplastic layers.

The first pane and the second pane are preferably made of glass, in particular of soda-lime glass, which is customary for window panes. In principle, however, the panes can also be produced from other types of glass (for example borosilicate glass, quartz glass, aluminosilicate glass) or transparent plastics (for example polymethyl methacrylate or polycarbonate). The thickness of the first pane being the outer pane can vary widely. Preferably, panes having a thickness in the range from 0.8 mm to 5 mm, preferably from 1.1 mm to 2.5 mm, are used, for example those with the standard thicknesses of 1.6 mm or 2.1 mm, wherein the second pane has a thickness of less than or equal to 1.6 mm, preferably less than or equal to 1.4 mm, particularly preferably 1.1 mm.

The second pane and the thermoplastic intermediate layer can be clear and colorless. The total transmittance through the windshield (incl. the reflective coating) is greater than 70% in a preferred embodiment. The term total transmittance relates to the method defined by ECE-R 43, Annex 3, § 9.1 for testing the light transmittance of motor vehicle panes. The first pane and the second pane may be not prestressed, may be partially prestressed, or may be prestressed, independently of one another. If at least one of the panes should be prestressed, this can be thermal or chemical prestressing.

In an advantageous embodiment, the first pane is tinted or colored. For example, green or blue-colored glass can be used as the first pane (e.g., outer pane). Such tinted glass panes are also known as TSANx, TSA3+ glass panes. This can reduce the outer-side reflectivity of the laminated pane, making the pane appear more pleasant to an outside viewer. At the same time, a good HUD representation with high contrast is enabled.

However, in order to ensure the prescribed light transmittance of 70% for windshields (total transmittance), the outer pane (i.e., the first pane in this case) should preferably have a light transmittance of at least 80%, particularly preferably at least 85%. The second pane and the intermediate layer are preferably clear, i.e., not tinted or colored.

The laminated pane is preferably curved in one or more spatial directions, as is usual for motor vehicle panes, wherein the typical radii of curvature are in a range of approximately 10 cm to approximately 40 m. However, the laminated pane can also be flat, for example if it is provided as a pane for buses, trains or tractors.

The thermoplastic intermediate layer comprises at least one thermoplastic polymer, preferably ethylene vinyl acetate (EVA), polyvinyl butyral (PVB) or polyurethane (PU), or mixtures, or copolymers, or derivatives thereof, particularly preferably PVB. The thermoplastic intermediate layer can be designed to have absorbing properties in the NIR region.

The laminated pane can be produced by methods known per se. The first pane and the second pane are laminated together via the intermediate layer, for example by autoclave processes, vacuum bag processes, vacuum ring processes, calendering processes, vacuum laminators, or combinations thereof. The outer pane and inner pane are usually connected under the effect of heat, vacuum and/or pressure.

The first coating and the second coating are preferably deposited by physical vapor deposition (PVD) onto a pane surface, particularly preferably by cathode sputtering, very particularly preferably by magnetic field-assisted cathode sputtering (“magnetron sputtering”) or by chemical deposition methods, in particular at atmospheric pressure. The coatings are preferably applied before lamination.

If something is formed “based on” a polymeric material, it consists predominantly, that is to say at least 50%, preferably at least 60%, and in particular at least 70%, of this material. It can thus also contain further materials such as, for example, stabilizers or plasticizers.

The invention also comprises a vehicle, preferably a road vehicle, in particular a passenger vehicle, which is equipped with a laminated pane according to the invention.

The invention also comprises a projection arrangement for a head-up display, wherein the projection arrangement comprises the laminated pane according to the invention and a projector, wherein the projector is directed toward the HUD region of the laminated pane, wherein the second surface (II) of the first pane and the second surface (IV) of the second pane are provided for irradiation by the projector. The radiation of the projector is predominantly p-polarized. The laminated pane is arranged relative to the projector such that the second surface (IV) of the second pane is the surface of the laminated pane closest to the projector.

The p-polarized radiation is reflected in the HUD region in the direction of a viewer, as a result of which a virtual HUD representation is generated which the viewer perceives, when viewed from their perspective, behind the laminated pane. The beam direction of the projector can typically be varied by mirrors, in particular vertically, in order to adapt the projection to the body size of the viewer. The area in which the observer's eyes must be located at a given mirror position is referred to as the eye box window. This eye box window can be displaced vertically by adjusting the mirrors, wherein the entire area accessible as a result (i.e., the superimposition of all possible eye-box windows) is referred to as the eye box. An observer located within the eye box can perceive the virtual image. This means, of course, that the observer's eyes must be located within the eye box, not, for instance, the entire body.

The projector is preferably a liquid-crystal display (LCD), thin-film transistor (TFT) display, light-emitting diode (LED) display, organic light-emitting diode (OLED) display, electroluminescent display (ELD), or micro-LED display.

The preferred embodiments of the laminated pane according to the invention described above also correspondingly apply to the projection arrangement comprising the laminated pane according to the invention and a projector.

The invention further extends to the use of the projection arrangement according to the invention in vehicles for traffic on land, in the air or on water, in particular in motor vehicles. The use of the laminated pane as a vehicle windshield is preferred.

The invention also relates to a method for producing a laminated pane for a head-up display (HUD), wherein the laminated pane has a first pane, a second pane, and a thermoplastic intermediate layer arranged between the first pane and the second pane, which thermoplastic intermediate layer has a wedge-shaped cross section, and wherein, in the method, at least:
a) a first pane and a second pane are provided, wherein the first pane has a first coating and the second pane has a second coating;
b) a thermoplastic intermediate layer having a wedge-shaped cross section is provided;
c) the thermoplastic intermediate layer is arranged flat between the first pane and the second pane, wherein the first coating is arranged between the first pane and the intermediate layer, and the second coating is arranged on a surface of the second pane facing away from the intermediate layer;
d) the first pane, the thermoplastic intermediate layer, and the second pane are connected by lamination.

The method can additionally comprise the steps of providing at least one additional intermediate layer and arranging it between the first and the second pane. The one additional intermediate layer is preferably a functional intermediate layer, in particular an IR-reflective layer, a layer absorbing UV radiation, a barrier layer, an intermediate layer with acoustic damping properties, or a combination thereof.

The various embodiments of the invention may be implemented individually or in any combinations. In particular, the features mentioned above and to be explained below can be used not only in the specified combinations but also in other combinations or alone without departing from the scope of the present invention.

In the following, the invention is explained in more detail with reference to figures and exemplary embodiments. The figures are schematic representations and not to scale. The figures do not limit the invention in any way.

In the figures:

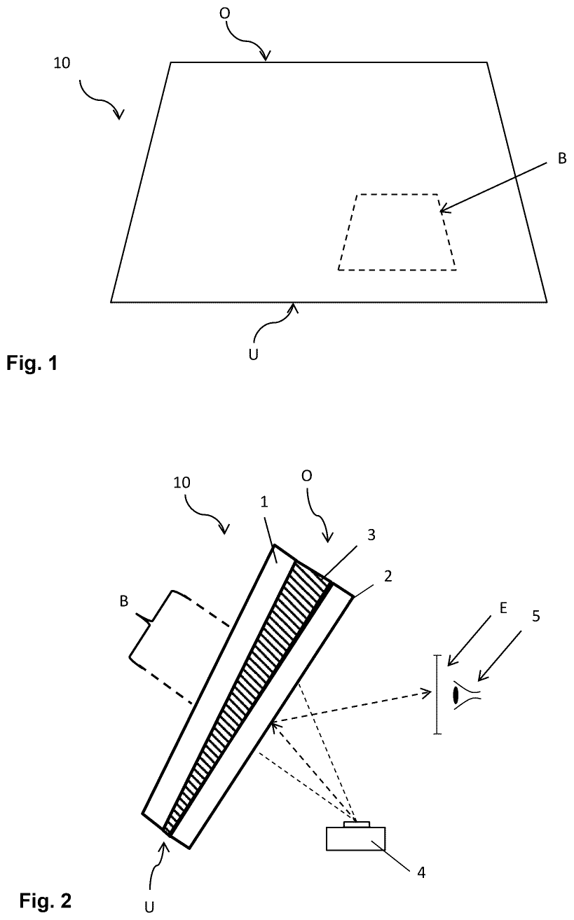

FIG. 1 shows a plan view of a laminated pane of a generic projection arrangement;

FIG. 2 shows a cross section through the laminated pane;

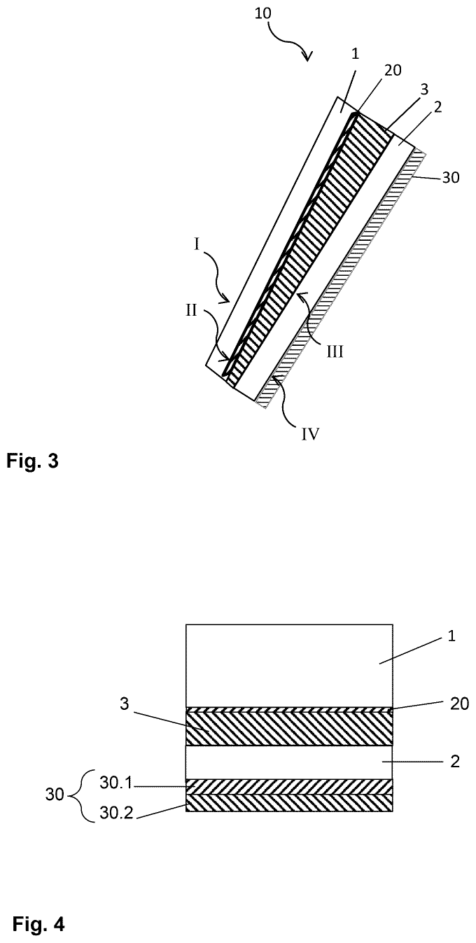

FIG. 3 shows a cross section through a first embodiment of a laminated pane according to the invention; and

FIG. 4 shows a cross section through an embodiment of a first coating and a second coating.

Data with numerical values are generally not to be understood as exact values, but also include a tolerance of +/−1% up to +/−10%.

FIG. 1 schematically shows a laminated pane 10 having an upper edge O, a lower edge U and a so-called HUD region B. In the installed state, the HUD region can be located in the lower region close to the lower edge of the laminated pane 10. A frame-shaped circumferential opaque cover layer can additionally be located in a circumferential edge region of the laminated pane 10.

FIG. 2 schematically shows a generic projection arrangement for an HUD system. The projection arrangement comprises the laminated pane 10, which is designed as a windshield of a passenger vehicle. The laminated pane 10 separates an interior of the passenger vehicle from an external environment. The projection arrangement furthermore has a projector 4 which is directed toward a region of the laminated pane 10. This region is usually referred to as HUD region B. Images generated by the projector 4 can be projected in this region, which are perceived by a viewer 5 (e.g., vehicle driver) as virtual images on the side of the laminated pane 10 facing away from such viewer when the viewer's eyes are within the so-called eye box E.

The laminated pane 10 is constructed from a first pane 1, being an outer pane, and a second pane 2, being an inner pane, of the passenger vehicle which are connected to one another via a thermoplastic intermediate layer 3. The thermoplastic intermediate layer 3 has a wedge-shaped cross section. The wedge angle of the intermediate layer 3 is 0.5 mrad. The intermediate layer 3 has a thicker first end and a thinner second end. The increase in thickness from the second end to the first end of the thermoplastic intermediate layer 3 is continuously linear. The thermoplastic intermediate layer 3 is colorless. The thermoplastic intermediate layer 3 is 0.76 mm thick at its thinner second end.

The lower edge U of the laminated pane 10 is arranged downward in the direction of the engine of the passenger vehicle, its upper edge O is arranged upward in the direction of the roof. In the installed position, the first pane 1 faces the external environment; the second pane 2 faces the vehicle interior. The laminated pane 1 can have any suitable geometric shape and/or curvature. As a windshield, it typically has a convex curvature.

FIG. 3 schematically shows a first embodiment of a laminated pane 10 according to the invention in cross section. The first pane 1 has an outer-side surface I which, in the installed position, faces the external environment, and an interior-side surface II which faces the interior in the installed position. The laminated pane 1 further comprises the second pane 2, which has an outer surface III and an interior-side surface IV. In the installed position, the surface Ill faces the external environment. In contrast, the surface IV faces the external environment in the installed position.

In the installed state, the first pane 1, being an outer pane, and the second pane 2, being an inner pane, consist, for example, of soda-lime glass. The first pane 1 has, for example, a thickness of 2.1 mm. The second pane 2 has a thickness of 1.6 mm and is thus significantly thinner than usually used inner panes in windshields. Alternatively, the thickness of the second pane (2) can be 1.4 mm or 1.1 mm. The reduction in the thickness of the second pane 2, i.e., of the inner pane in the installed state of a vehicle, is accompanied by an adaptation of the first reflection to the second reflection. This means that the image produced at the second surface IV of the second pane 2 comes closer to the image from the second reflection produced at the second surface of the first pane II. The images overlap more strongly, as a result of which the impression of the resulting HUD representation is improved.

The first pane 1 has at least one tinting. Due to the tinting of the first pane 1, a good HUD representation (projector image) with high contrast is possible. The intermediate layer 3 is formed, for example, from a PVB film. The thermoplastic intermediate layer 3 has a wedge-shaped cross section. The wedge angle of the intermediate layer 3 is 0.5 mrad. The intermediate layer 3 has a thicker first end and a thinner second end. The increase in thickness from the second end to the first end of the thermoplastic intermediate layer 3 is continuously linear. The thermoplastic intermediate layer 3 is colorless. At its thinner second end, the thermoplastic intermediate layer 3 is 0.76 mm or alternatively 0.38 mm thick. The PVB film can be designed to have absorbing properties in the NIR region.

The second (interior-side) surface II of the first pane 1 is provided with a first coating 20 according to the invention, which has a refractive index of at least 1.9. The first coating 20 has a layer of an optically highly refractive material. The optically highly refractive layer of the first coating 20 is preferably formed on the basis of silicon nitride, silicon-metal mixed nitrides, such as silicon zirconium nitride (SiZrNx), silicon titanium mixed nitride or silicon hafnium mixed nitride. The layer thickness of the optically highly refractive layer should preferably be 20 nm to 80 nm, particularly preferably 30 nm.

The second (inner-side) surface IV of the second pane 2 is provided with a second coating 30 according to the invention. The first coating 20 according to the invention and the second coating 30 are optimized for the reflection of p-polarized radiation. They serve as reflection surfaces for the radiation of the projector 4 for generating the HUD projection. A first reflection takes place at the first coating 20. However, since the angle of incidence of the projector radiation deviates slightly from the Brewster angle, a second reflection of the projector radiation takes place also at the air glass transitions, which leads to the formation of a second image. Due to the very small thickness of the second pane 2, the second image, which is produced by the second reflection at the interior-side surface IV of the pane 2, can overlap well with the main image generated by the first reflection at the first coating 20. Since the intensity of the reflected radiation (in contrast to the reflection at the outer surface I of the outer pane 1) is not already weakened by passing through the second coating 30, the second image increases the visibility of the first image resulting from the reflection at the first coating 20.

When looking through the laminated pane 1 from inside the passenger vehicle, the first coating 20 and the second coating 30 are arranged in front of the tinted first pane 1 (outer pane). As a result, when the first and second coating 20, 30 are irradiated with p-polarized light 10 of the projector 4, a particularly high-contrast and visually clearly perceptible HUD representation is produced.

The radiation of the projector 4 is largely p-polarized. Since the projector 4 irradiates the laminated pane 10 with an angle of incidence of approximately 65° to 75°, which is close to the so-called Brewster angle, the radiation of the projector is reflected only to an insignificant extent at the first (outside) surface I of the laminated pane 10. The projector 4 is, for example, a display, in the present case an LCD display. It would also be possible, for example, for the laminated pane 10 to be a roof panel, side pane, or rear pane. The p-polarized radiation is constituted by light waves within the wavelength range from 380 nm to 780 nm visually perceptible to humans.

FIG. 4 shows the layer sequence of an exemplary embodiment of the second coating 30. The second coating 30 comprises a first layer of a dielectric material 30.1 having a refractive index of greater than or equal to 1.9 and a second layer of a dielectric material 30.2 having a refractive index of less than or equal to 1.6. The first layer of the second coating 30 has a dielectric material 30.1 based on silicon nitride, silicon metal mixed nitrides, such as silicon zirconium nitride (SiZrNx), silicon titanium mixed nitride or silicon hafnium mixed nitride. The second layer 30.2 of the second coating 30 has a dielectric material 30.2 based on silicon oxide (SiO₂). Compared to the first layer, the second layer is an optically low-refractive layer. The layer thicknesses of the dielectric layers of the second coating 30 should preferably be 50 nm to 200 nm, particularly preferably 70 nm to 115 nm.

The first layer 30.1 and the second layer 30.2 of the second coating 30 are arranged congruently one above the other, wherein the first layer 30.1 is applied to the second surface IV of the second pane 2 and the second layer 30.2 is applied to the first layer 30.1.

While it would intuitively be obvious to reduce the reflection at the second surface IV of the second pane 2 by means of a reflection-reducing coating (anti-reflective coating), the interior-side surface IV of the second pane 2 is, quite to the contrary, provided according to the invention with a reflection-increasing coating 30, which increases the total reflectivity of the second surface IV.

The layer sequences of a laminated pane 10 with the first coating 20 on the second (interior-side) surface II of the first pane 1 and the second coating 30 on the second (interior-side) surface IV of the second pane 2 according to Example 1 according to the invention are presented in Table 1 along with the materials and geometric layer thicknesses of the individual layers.

TABLE 1

| | | |
|---|---|---|
| Material | Reference signs | Layer thickness |

| | | | | |
|---|---|---|---|---|
| SiO₂ | 30.2 | 30 | 115 | nm |
| SiZrN | 30.1 | | 70 | nm |

| | | | |
|---|---|---|---|
| Soda-lime glass | 2 | 1.6 | mm |
| PVB | 3 | 0.76 | mm |
| SiZrN | 20 | 30 | nm |
| Soda-lime glass | 1 | 2.1 | mm |

The TTS value of the laminated pane is improved up to 3%, i.e., reduced, by additional absorption of the thermal radiation at the intermediate layer 3. This result was unexpected and surprising for the person skilled in the art.

A significant advantage of the laminated pane 10 according to the invention is that high-frequency signals can penetrate the laminated pane 10 while, at the same time, the reflectivity is improved with regard to HUD representations. Also, the external reflection color is relatively neutral (bluish/green tinge), so that the laminated pane does not have an unpleasant tint (e.g., reddish tinge).

### LIST OF REFERENCE SIGNS

1 First pane
2 Second pane
3 Thermoplastic intermediate layer
4 Projector
5 Viewer/vehicle driver
10 Laminated pane
20 First coating
30 Second coating
30.1 First layer of the second coating 30
30.2 Second layer of the second coating 30
O Upper edge of the laminated windshield 10
U Lower edge of the laminated windshield 10
B HUD region of the laminated windshield 10
E Eye box
I First surface of the first pane 1 facing away from the intermediate layer 3
II Second surface of the first pane 1 facing the intermediate layer 3
III First surface of the second pane 2 facing the intermediate layer 3
IV Second surface of the second pane 2 facing away from the intermediate layer 3

1. A laminated pane for a head-up display system, comprising:
a first pane having a first surface and a second surface, a second pane having a first surface and a second surface, and a thermoplastic intermediate layer having a wedge-shaped cross section arranged between the second surface of the first pane and the first surface of the second pane,
a first coating on the second surface of the first pane facing the thermoplastic intermediate layer,
a second coating on the surface of the second pane facing away from the thermoplastic intermediate layer,
an HUD region having the first coating and the second coating,
wherein the first coating and the second coating are provided for reflecting p-polarized radiation,
wherein a refractive index of the first coating is at least 1.9,
wherein the second coating comprises at least one first layer of a dielectric material having a refractive index of greater than or equal to 1.9 and a second layer of a dielectric material having a refractive index of less than or equal to 1.6,
wherein the second pane has a smaller thickness than the first pane, and wherein the first coating and the second coating have exclusively dielectric layers.

2. The laminated pane according to claim 1, wherein the first coating and the second coating are free of electrically conductive materials.

3. The laminated pane according to claim 1, wherein the first pane has a tinting.

4. The laminated pane according to claim 1, wherein the first coating comprises a dielectric layer based on silicon zirconium mixed nitride, silicon nitride, silicon titanium mixed nitride, silicon hafnium mixed nitride and/or titanium oxide.

5. The laminated pane according to claim 1, wherein the first layer of the second coating comprises a dielectric layer based on silicon zirconium mixed nitride, silicon nitride, silicon titanium mixed nitride, silicon hafnium mixed nitride, indium tin oxide or titanium oxide, the second layer of the second coating comprises a dielectric layer based on a dielectric oxide, in particular silicon oxide or doped silicon oxide, and wherein the first layer of the second coating is arranged closer to the second pane than the second layer of the second coating.

6. The laminated pane according to claim 1, wherein the second coating has a total material thickness of at most 200 nm.

7. The laminated pane according to claim 1, wherein the thermoplastic intermediate layer has a wedge angle in the range of 0.1 mrad to 1 mrad.

8. The laminated pane according to claim 1, wherein the thermoplastic intermediate layer comprises at least one thermoplastic polymer.

9. The laminated pane according to claim 1, wherein the thermoplastic intermediate layer has a film with absorbing properties in the 780 nm to 3000 nm wavelength range.

10. The laminated pane according to claim 1, wherein the second pane has a thickness of less than or equal to 1.6 mm.

11. The laminated pane according to claim 1, wherein the first coating and the second coating have been deposited by magnetron sputtering or by a chemical deposition method.

12. The laminated pane according to claim 1, wherein the laminated pane is the windshield of a passenger vehicle.

13. A vehicle having a laminated pane according to claim 1.

14. A projection arrangement for a head-up display system, comprising:
a laminated pane according to claim 1, and
a projector directed toward the HUD region of the laminated pane, wherein the second surface of the second pane is provided for irradiation by the projector, and wherein the radiation of the projector is predominantly p-polarized.

15. A method for producing a laminated pane according to claim 1, the method comprising:
providing the first pane and the second pane, wherein the first pane has the first coating and the second pane has a second coating,
providing a thermoplastic intermediate layer having a wedge-shaped cross section,
arranging the thermoplastic intermediate layer flat between the first pane and the second pane, wherein the first coating is arranged between the first pane and the thermoplastic intermediate layer, and the second coating is arranged on a surface of the second pane facing away from the thermoplastic intermediate layer, and
connecting the first pane, the thermoplastic intermediate layer, and the second pane by lamination.

16. The laminated pane according to claim 6, wherein the second coating has a total material thickness of at most 185 nm.

17. The laminated pane according to claim 7, wherein the wedge angle is in the range of 0.3 mrad to 0.6 mrad.

18. The laminated pane according to claim 8, wherein the at least one thermoplastic polymer is ethylene vinyl acetate (EVA), polyvinyl butyral (PVB) or polyurethane (PU), or mixtures, or copolymers, or derivatives thereof.

19. The laminated pane according to claim 10, wherein the second pane has a thickness of less than or equal to 1.1 mm.

20. The laminated pane according to claim 11, wherein the first coating and the second coating have been deposited by magnetron sputtering or by a chemical deposition method at atmospheric pressure.
